(19) United States
(12) Patent Application Publication
(10) Pub. No.: US 2023/0135296 A1
(43) Pub. Date: May 4, 2023

(54) POLYMER COMPOSITIONS COMPRISING CELLULOSE ESTERS

(71) Applicant: Eastman Chemical (China) Co., Ltd, Pudong New District (CN)

(72) Inventors: Devin G Barrett, Jonesborough, TN (US); Jian Qiu Shi, Shanghai (CN); Franklin Delano Rector, JR., Kingsport, TN (US)

(73) Assignee: Eastman Chemical (China) Co., Ltd, Pudong New District (CN)

(21) Appl. No.: 17/754,674

(22) PCT Filed: Oct. 8, 2019
(86) PCT No.: PCT/CN2019/110007

§ 371 Date: Apr. 8, 2022

(51) Int. Cl. C08L 1/14; D01F 1/02; D01F 6/94; D01F 6/92; D01F 6/90; D01F 6/46

(52) U.S. Cl. CPC C08L 1/14; D01F 1/02; D01F 6/94; D01F 6/92; D01F 6/90; D01F 6/46

(57) ABSTRACT

Provided are certain cellulose ester compositions which serve as improved anti-tack additives for various thermoplastic polymers, in applications such as woven and non-woven fibers, laminates including the composition, fabrics including the composition, apparel and garments, textiles including the composition, etc.

### FIELD OF THE INVENTION

The invention belongs to the field of polymer science. In particular, it relates to compositions having improved anti-tack properties comprising thermoplastic polymers and certain cellulose esters.

### BACKGROUND OF THE INVENTION

Elastane polymers are used in many applications. One issue with these polymers is tackiness, which can manifest in various applications. One common problem due to tackiness is that spun fibers can stick together, which prevents smooth unwinding from a bobbin. This causes inconsistent tension on the fiber spinning line and can lead to fiber breakage during spinning. Known anti-tack additives like silicone finishing oil or magnesium stearate can be added to the polymer dope solutions before or after spinning but such additives create problems on their own. Silicone finishing oil, while providing excellent block resistance and reducing coefficient of friction during processing, can be difficult to remove in the scouring process. Thus, there remains a need for improved anti-tack additives for elastane polymers as well as other thermoplastic polymers for various applications

### SUMMARY OF THE INVENTION

The invention is as set forth in the appended claims. In general, the invention provides certain cellulose ester compositions which serve as improved anti-tack additives for various thermoplastic polymers, in applications such as woven and non-woven fibers, laminates including the composition, fabrics including the composition, apparel and garments, textiles including the composition, etc.

### DETAILED DESCRIPTION OF THE INVENTION

In a first aspect, the invention provides a polymer composition comprising

(a) at least one of a polymer chosen from polyolefins, nylons, polyesters, polyurethaneureas, and mixtures thereof; and

(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of greater than 0.01 to about 0.3;
(iv) a DS of hydroxyl of about 0.05 to about 0.25;
   and a Mₙ of about 2000 to about 50,000.

In other embodiments, the DS of butyryl is about 0.10 to about 0.20. In other embodiments, the DS of hydroxyl is about 0.10 to about 0.20. In other embodiments, the number average molecular weight (Mₙ) is about 5000 to about 30,000 or about 10,000 to about 25,000.

In this aspect of the invention, the cellulose ester is solvent blended with the thermoplastic polymers chosen from polyolefins, nylons, polyesters, polyurethanes, and polyurethaneureas, and mixtures thereof, in order to improve the anti-tack properties of the resulting polymer composition. In a further embodiment, the composition may further comprise an additional additive such as calcium stearate, magnesium stearate, organic stearates, silicon oil, mineral oil, and mixtures thereof. These components can be added to the polymer composition prior to further processing of the composition such as spinning of the fiber or casting or extruding a film.

Polymer compositions utilized in the present invention may include materials capable of being extruded or cast as films such as polyolefins (including elastomeric polyolefins), nylons, polyesters, and the like. Such polymers can be thermoplastic materials such as polyethylene, low density polyethylene, linear low density polyethylene, polypropylenes and copolymers and blends containing substantial fractions of these materials. The products prepared from the polymer compositions, such as fibers or films, can be treated with surface modifying agents to impart hydrophilic or hydrophobic properties, such as imparting a lotus effect. For example, polymer containing articles such as films can be textured, embossed, or otherwise altered from a strictly flat, planar configuration.

In certain embodiments, the polymer composition component (a) is comprised of at least one polyurethane or polyurethaneurea. Such polymers may generally be prepared by capping a macromolecular glycol with, for example, a diisocyanate, then dissolving the resulting capped glycol in a suitable solvent (e.g., dimethylacetamide (DMAc), N-methylpyrrolidone, dimethylformamide, and the like), and chain-extending the capped glycol with chain extenders such as diols to form polyurethanes, or diamines to form polyurethaneureas. Polyurethaneurea compositions useful for preparing fiber or long chain synthetic polymers include at least 85% by weight of a segmented polyurethane. Typically, these include a polymeric glycol which is reacted with a diisocyanate to form an NCO-terminated prepolymer (a “capped glycol”), which is then dissolved in a suitable solvent, such as dimethylacetamide, dimethylformamide, or N-methylpyrrolidone, and secondarily reacted with a difunctional chain extender.

Polyurethanes are formed in a second step when the chain extenders are diols (and may be prepared without solvent). Polyurethaneureas, a sub-class of polyurethanes, are formed when the chain extenders are diamines. In the preparation of a polyurethaneurea polymer which can be spun into spandex, the glycols are extended by sequential reaction of the hydroxy end groups with diisocyanates and one or more diamines. In each case, the glycols must undergo chain extension to provide a polymer with the necessary properties, including viscosity. If desired, dibutyltin dilaurate, stannous octoate, mineral acids, tertiary amines such as triethylamine, N,N′-dimethylpiperazine, and the like, and other known catalysts can be used to assist in the capping step.

In one embodiment, suitable polymeric glycol components include, but are not limited to, polyether glycols, polycarbonate glycols, and polyester glycols of number average molecular weight of about 600 to 3,500. Mixtures of two or more polymeric glycol or copolymers may be utilized.

In one embodiment, examples of polyether glycols that can be used include, but are not limited to, those glycols with two hydroxyl groups, from ring-opening polymerization and/or copolymerization of ethylene oxide, propylene oxide, trimethylene oxide, tetrahydrofuran, and 3-methyltetrahydrofuran, or from condensation polymerization of a polyhydric alcohol, such as a diol or diol mixtures, with less than 12 carbon atoms in each molecule, such as ethylene glycol, 1,3-propanediol, 1,4-butanediol, 1,5-pentanediol 1,6-hexanediol, 2,2-dimethyl-1,3 propanediol, 3-methyl-1,5-pentanediol, 1,7-heptanediol, 1,8-octanediol, 1,9-nonanediol, 1,10-decanediol and 1,12-dodecanediol. A poly(tetramethylene ether) glycol of molecular weight of about 1,700 to about 2,100, such as Terathane® 1800 (INVISTA) with a functionality of 2, is an example of a specific suitable glycol. Copolymers can include poly(tetramethylene-co-ethylene ether) glycol.

Other examples of polyester polyols that can be used include, but are not limited to, those ester glycols with two hydroxyl groups, produced by condensation polymerization of aliphatic polycarboxylic acids and polyols, or their mixtures, of low molecular weights with no more than 12 carbon atoms in each molecule. Examples of suitable polycarboxylic acids include, but are not limited to, malonic acid, succinic acid, glutaric acid, adipic acid, pimelic acid, suberic acid, azelaic acid, sebacic acid, undecanedicarboxylic acid, and dodecanedicarboxylic acid. Examples of suitable polyols for preparing the polyester polyols include, but are not limited to, ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear bifunctional polyester polyol with a melting temperature of about 5° C. to 50° C. is an example of a suitable polyester polyol.

Examples of polycarbonate polyols that can be used include, but are not limited to, those carbonate glycols with two or more hydroxy groups, produced by condensation polymerization of phosgene, chloroformic acid ester, dialkyl carbonate or diallyl carbonate and aliphatic polyols, or their mixtures, of low molecular weights with no more than 12 carbon atoms in each molecule. Examples of suitable polyols for preparing the polycarbonate polyols include, but are not limited to, diethylene glycol, 1,3-propanediol, 1,4-butanediol, 1,5-pentanediol, 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polycarbonate polyol with a melting temperature of about 5° C. to about 50° C. is an example of a suitable polycarbonate polyol.

The diisocyanate component can also include a single diisocyanate or a mixture of different diisocyanates including an isomer mixture of diphenylmethane diisocyanate (MDI) containing 4,4′-methylene bis(phenyl isocyanate) and 2,4′-methylene bis(phenyl isocyanate). Any suitable aromatic or aliphatic diisocyanate can be included. Examples of diisocyanates that can be used include, but are not limited to, 4,4′-methylene bis(phenyl isocyanate), 2,4′-methylene bis(phenyl isocyanate), 4,4′-methylenebis(cyclohexyl isocyanate), 1,3-diisocyanato-4-methyl-benzene, 2,2′-toluenediisocyanate, 2,4′-toluenediisocyanate, and mixtures thereof.

A chain extender may be either water or a diamine chain extender for a polyurethaneurea. Combinations of different chain extenders may be included depending on the desired properties of the polyurethaneurea and the resulting polymer composition or fiber. Examples of suitable diamine chain extenders include, but are not limited to: hydrazine; 1,2-ethylenediamine; 1,4-butanediamine; 1,2-butanediamine; 1,3-butanediamine; 1,3-diamino-2,2-dimethylbutane; 1,6-hexamethylenediamine; 1,12-dodecanediamine; 1,2-propanediamine; 1,3-propanediamine; 2-methyl-1,5-pentanediamine; 1-amino-3,3,5-trimethyl-5-aminomethylcyclohexane; 2,4-diamino-1-methylcyclohexane; N-methylamino-bis(3-propylamine); 1,2-cyclohexanediamine; 1,4-cyclohexanediamine; 4,4′-methylene-bis(cyclohexylamine); isophorone diamine; 2,2-dimethyl-1,3-propanediamine; meta-tetramethylxylenediamine; 1,3-diamino-4-methylcyclohexane; 1,3-cyclohexane-diamine; 1,1-methylene-bis(4,4′-diaminohexane); 3-aminomethyl-3,5,5-trimethylcyclohexane; 1,3-pentanediamine (1,3-diaminopentane); m-xylylene diamine; and Jeffamine® polyetheramines (Huntsman).

When a polyurethane is desired, the chain extender is a diol. Examples of such diols that may be used include, but are not limited to, ethylene glycol, 1,3-propanediol, 1,2-propylene glycol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, and 1,4-butanediol, hexanediol and mixtures thereof.

In one embodiment, a monofunctional alcohol or a primary/secondary monofunctional amine may optionally be included to control the molecular weight of the polymer. Blends of one or more monofunctional alcohols with one or more monofunctional amines may also be included. Examples of monofunctional alcohols include, but are not limited to, at least one member chosen from aliphatic and cycloaliphatic primary and secondary alcohols with 1 to 18 carbons, phenol, substituted phenols, ethoxylated alkyl phenols and ethoxylated fatty alcohols with molecular weight less than about 750, including molecular weight less than 500, hydroxyamines, hydroxymethyl and hydroxyethyl substituted tertiary amines, hydroxymethyl and hydroxyethyl substituted heterocyclic compounds, and combinations thereof, including furfuryl alcohol, tetrahydrofurfuryl alcohol, N-(2-hydroxyethyl)succinimide, 4-(2-hydroxyethyl)morpholine, methanol, ethanol, butanol, neopentyl alcohol, hexanol, cyclohexanol, cyclohexanemethanol, benzyl alcohol, octanol, octadecanol, N,N-diethylhydroxylamine, 2-(diethylamino)ethanol, 2-dimethylaminoethanol, and 4-piperidineethanol, and combinations thereof. Examples of suitable mono-functional dialkylamine blocking agents include, but not limited to: N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tort-butyl-N-isopropylamine, N-isopropyl-N-cyclohexylamine, N-ethyl-N-cyclohexylamine, N,N-diethanolamine, and 2,2,6,6-tetramethylpiperidine. Further details on the manufacture of the polyurethanes and polyurethaneureas may be found in U.S. Pat. Nos. 9,637,624, 9,796,791, and 8,377,554, incorporated herein by reference.

Examples of polyurethanes and polyurethaneureas include those products sold as elastanes. Particular elastanes include those sold under the marks LYCRA, HYFIT, ELASPON, DORLASTAN, ACEPORA, CREORA, LINEL, and ESPA.

The cellulose esters of the invention (component (b)) generally comprise repeating units of the structure:

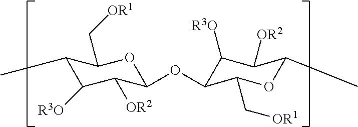

wherein R¹, R², and R³ may be chosen independently from hydrogen or a straight chain alkanoyl group. For cellulose esters, the substitution level is usually expressed in terms of degree of substitution (“DS”), which is the average number of substituents per anhydroglucose unit (“AGU”).

Because DS is a statistical mean value, a value of 1 does not assure that every AGU has a single substituent. In some cases, there can be unsubstituted AGUs, some with two substituents, and some with three substituents. The “total DS” is defined as the average number of substituents per AGU.

In certain embodiments, the cellulose esters can have an inherent viscosity (“IV”) of at least about 0.1, 0.2, 0.4, 0.6, 0.8, or 1.0 deciliters/gram as measured at a temperature of 25° C. for a 0.25 gram sample in 100 ml of acetone. Additionally or alternatively, the cellulose esters can have an IV of not more than about 3.0, 2.5, 2.0, or 1.5 deciliters/gram as measured at a temperature of 25° C. for a 0.25 gram sample in 100 ml of acetone.

In certain embodiments, the cellulose esters can have a falling ball viscosity of at least about 0.005, 0.01, 0.05, 0.1, 0.5, 1, or 5 seconds. Additionally or alternatively, the cellulose esters can have a falling ball viscosity of not more than about 50, 45, 40, 35, 30, 25, 20, or 10 seconds. In certain embodiments, the cellulose esters can have a hydroxyl content of at least about 0.5, 0.8, 1.0, 1.2, 1.4, 1.6, 1.8, or 2.0 weight percent.

In certain embodiments, the cellulose esters useful in the present invention can have a weight average molecular weight (M_{w}) of at least about 5,000, 10,000, 15,000, or 20,000 as measured by gel permeation chromatography (“GPC”). Additionally or alternatively, the cellulose esters useful in the present invention can have a weight average molecular weight (M_{w}) of not more than about 400,000, 300,000, 250,000, 100,000, or 80,000 as measured by GPC. In another embodiment, the cellulose esters useful in the present invention can have a number average molecular weight (Mₙ) of at least about 2,000, 4,000, 6,000, or 8,000 as measured by GPC. Additionally or alternatively, the cellulose esters useful in the present invention can have a number average molecular weight (Mₙ) of not more than about 100,000, 80,000, 60,000, or 40,000 as measured by GPC.

In certain embodiments, the cellulose esters can have a glass transition temperature (“Tg”) of at least about 50° C., 55° C., 60° C., 65° C., 70° C., 75° C., or 80° C. Additionally or alternatively, the cellulose esters can have a Tg of not more than about 125° C.

The cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and from sources such as, for example, cotton linters, softwood pulp, hardwood pulp, corn fiber and other agricultural sources, and bacterial celluloses.

One method of producing cellulose esters is by esterification. In such a method, the cellulose is mixed with the appropriate organic acids, acid anhydrides, and catalysts and then converted to a cellulose triester. Ester hydrolysis is then performed by adding a water-acid mixture to the cellulose triester, which can be filtered to remove any gel particles or fibers. Water is added to the mixture to precipitate out the cellulose ester. The cellulose ester can be washed with water to remove reaction by-products followed by dewatering and drying.

The cellulose triesters that are hydrolyzed can have three substitutents selected independently from alkanoyls having from 2 to 10 carbon atoms. Examples of cellulose triesters include cellulose propionate, and mixed esters of cellulose such as cellulose acetate propionate butyrate and cellulose propionate butyrate. These cellulose triesters can be prepared by a number of methods known to those skilled in the art. For example, cellulose triesters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

After esterification of the cellulose to the triester, part of the acyl substitutents can be removed by hydrolysis or by alcoholysis to give a secondary cellulose ester. Secondary cellulose esters can also be prepared directly with no hydrolysis by using a limiting amount of acylating reagent. This process is particularly useful when the reaction is conducted in a solvent that will dissolve cellulose.

In one embodiment, the polymer composition of the present invention comprises, for example, about 0.1% to 1.0%, about 0.1% to 5%, about 0.1% to 10.0%, about 0.1% to 15.0%, about 0.1% to 20%, about 0.1% to 25%, about 0.1% to 50.0%, about 0.5% to about 5.0% and about 1.0% to 5.0% of the cellulose ester (component (b)) by weight of the polymer composition.

After synthesizing the polymer solution of the invention (component (a)), the cellulose ester (component (b)) may be incorporated into the solution. Typical solvents for the components of the composition include dimethyl acetamide (DMAC), dimethyl formamide (DMF), and N-methyl pyrrolidone (NMP). The solution having the cellulose ester dissolved therein may be dry-spun to form an elastic fiber. Dry-spinning refers to the process of forcing a polymer solution through spinneret orifices into a shaft to form a filament. Heated inert gas may then be passed through the chamber, evaporating the solvent from the filament as the filament passes through the shaft. The resulting elastic fiber may then be wound on a cylindrical core to form an elastane supply package. (See, for example, U.S. Pat. No. 9,637,624, incorporated herein by reference.) A wet-spinning process may also be used as well as the casting and drying of the polymer solution.

As noted above, the polymer compositions of the invention are useful in manufacturing fibers having improved anti-tack properties. Accordingly, in another aspect, the invention provides a process for preparing a fiber comprising:

(a) preparing a composition comprising at least one of a polymer chosen from polyurethanes, polyolefins, nylons, polyesters, polyurethaneureas, and mixtures thereof; and

(b) about 0.1% to about 25% by weight of a cellulose ester having (i) a DS of acetyl of about 0 to about 0.15;
(ii) a DS of propionyl of about 2.55 to about 2.85; and
(iii) a DS of butyryl of about 0.01 to about 0.3;
(iv) a DS of hydroxyl of about 0.05 to about 0.25;
   and a Mₙ of about 2000 to about 50,000;

(c) adding to the composition at least one lubricant; and

(d) preparing fiber from the composition by a spinning process chosen from wet spinning, dry spinning, and melt spinning. It should be recognized that step (c) may take place prior to step (d) or may take place after or during step (d), i.e., the spinning of the fibers.

In a further aspect, the invention provides a fiber comprising:

(a) at least one of a polymer chosen from polyurethanes, polyolefins, nylons, polyesters, polyurethaneureas, and mixtures thereof; and

(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of about 0.01 to about 0.3;
(iv) a DS of hydroxyl of about 0.05 to about 0.25;
   and a Mₙ of about 2000 to about 50,000.

As used herein, the term “fiber” refers to filamentous material that can be used in fabric and yarn as well as textile fabrication. One or more fibers can be used to produce a fabric or yarn. The yarn can be fully drawn or textured according to known methods. Such fibers can be prepared by means known in the art, for example as described in U.S. Pat. No. 8,262,958, incorporated herein by reference. In such methods, typically upon exiting a spinneret, the fibers are quenched with a cross flow of air whereupon the fibers solidify. Various lubricants, i.e., finishes and sizes may be applied to the fiber at this stage. The cooled fibers, typically, are subsequently drawn and wound up on a take up spool. Other additives may be incorporated in the finish in effective amounts like emulsifiers, antistatics, antimicrobials, antifoams, lubricants, thermostabilizers, UV stabilizers, and the like.

Optionally, the drawn fibers may be textured and wound-up to form a bulky continuous filament. This one-step technique is known in the art as spin-draw-texturing. Other embodiments include flat filament (non-textured) yarns, or cut staple fiber, either crimped or uncrimped.

In a further aspect, the invention provides an article comprising the fibers described herein. As used herein, the term “article” is understood to mean any article having or resembling fibers. Non-limiting examples of such articles include multifilament fibers, yarns, cords, tapes, fabrics, melt blown webs, spunbonded webs, thermobonded webs, hydroentangled webs, nonwoven webs and fabrics, and combinations thereof; items having one or more layers of fibers, such as, for example, multilayer nonwovens, laminates, and composites from such fibers, gauzes, bandages, diapers, training pants, tampons, surgical gowns and masks, feminine napkins; and the like. Further, the articles may include replacement inserts for various personal hygiene and cleaning products. The article of the present invention may be bonded, laminated, attached to, or used in conjunction with other materials. The article, for example a nonwoven fabric layer, may be bonded to a flexible plastic film or backing of a water-nondispersible material, such as polyethylene. Such an assembly, for example, could be used as one component of a disposable diaper. In addition, the article may result from overblowing fibers onto another substrate to form highly assorted combinations of engineered melt blown, spunbond, film, or membrane structures.

The articles of the present invention include woven and nonwoven fabrics and webs. Woven fabrics may then be further processed into articles of apparel. A nonwoven fabric is defined as a fabric made directly from fibrous webs without weaving or knitting operations. For example, the multicomponent fiber of the present invention may be formed into a fabric by any known fabric forming process like knitting, weaving, needle punching, and hydroentangling.

As noted above, the articles may include personal and health care products such as, but not limited to, child care products, such as infant diapers; child training pants; adult care products, such as adult diapers and adult incontinence pads; feminine care products, such as feminine napkins, panty liners, and tampons; wipes; fiber-containing cleaning products; medical and surgical care products, such as medical wipes, tissues, gauzes, examination bed coverings, surgical masks, gowns, bandages, and wound dressings; fabrics; elastomeric yarns, wipes, tapes, other protective barriers, and packaging material. The articles may be used to absorb liquids or may be pre-moistened with various liquid compositions and used to deliver these compositions to a surface. Non-limiting examples of liquid compositions include detergents; wetting agents; cleaning agents; skin care products, such as cosmetics, ointments, medications, emollients, and fragrances. The fibrous articles also may include various powders and particulates to improve absorbency or as delivery vehicles. Examples of powders and particulates include, but are not limited to, talc, starches, various water absorbent, water-dispersible, or water swellable polymers, such as super absorbent polymers, sulfopolyesters, and poly(vinylalcohols), silica, pigments, and microcapsules. Additives may also be present, but are not required, as needed for specific applications. Examples of additives include, but are not limited to, oxidative stabilizers, UV absorbers, colorants, pigments, opacifiers (delustrants), optical brighteners, fillers, nucleating agents, plasticizers, viscosity modifiers, surface modifiers, antimicrobials, disinfectants, cold flow inhibitors, branching agents, and catalysts. Such additives, can be present in amounts by weight of about 0.1% to 1.0%, about 0.1% to 2.0%, about 0.1% to 3.0%, about 0.1% to 4.0%, about 0.1% to 5.0%, about 0.1% to 6.0%, about 0.1% to 7.0%, about 0.1% to 8.0%, about 0.1% to 9.0%, or about 0.1% to 10.0%, based on the weight of the fiber.

Accordingly, in a further embodiment, the invention provides an article comprising a fiber comprising

(a) at least one of a polymer chosen from polyurethanes, polyolefins, nylons, polyesters, polyurethaneureas, and mixtures thereof; and

(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of about 0.01 to about 0.3;
(iv) a DS of hydroxyl of about 0.05 to about 0.25;
and a Mₙ of about 2000 to about 50,000.

In a further embodiment, the invention provides laminate structures comprises a fiber or film of the present invention, which has at least one of a polyurethane or polyurethaneurea (component (a)), about 0.1% to 25% by weight of the cellulose ester of the invention (component (b)) and at least one additional lubricant additive, such as calcium stearate, magnesium stearate, organic stearate, silicon oil, mineral oil, and mixtures thereof. In certain embodiments, the fiber is adhered to one or more layers of a substrate, such as a fabric, nonwoven, film, and combinations thereof. The laminate structure may be adhered by an adhesive, ultrasonic bonding, thermal bonding or combinations thereof. The laminate structure may comprise a disposable hygiene article such as diapers, training pants, adult incontinence articles, or feminine hygiene articles.

Accordingly, in a further aspect, the invention provides a laminate structure comprising a fiber comprising:

(a) at least one of a polymer chosen from polyurethanes, polyolefins, nylons, polyesters, polyurethaneureas, and mixtures thereof; and

(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of about 0.01 to about 0.3;
(iv) a DS of hydroxyl of about 0.05 to about 0.25;
   and a Mₙ of about 2000 to about 50,000;
   wherein said fiber is adhered to one or more layers of a substrate chosen from fabric, nonwoven, film, and combinations thereof.

In a further embodiment, the invention provides articles of apparel comprising the fibers of the invention. In this embodiment, the cellulose esters include cellulose propionate, cellulose acetate propionate butyrate, and cellulose propionate butyrate. Accordingly, in a further aspect, the invention provides an item of apparel, comprising fibers comprising:

(a) at least one of a polymer chosen from polyurethanes, polyolefins, nylons, polyesters, polyurethaneureas, and mixtures thereof; and

(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of about 0.0 to about 0.3;
(iv) a DS of hydroxyl of about 0.05 to about 0.25, provided that when the DS of butyryl is 0, the DS of acetyl is 0;
   and a Mₙ of about 2000 to about 50,000.

In certain embodiments, the items of apparel are woven materials constructed of low denier warp knit fabrics. In this regard, such fabrics tend to have fibers having a denier of about 15D to about 40D. In certain embodiments, the apparel article is constructed of the fibers of the invention which have been subjected to warp knitting and are chosen from Raschel, Milanese, and Tricot knits. In certain embodiments, the items of apparel are chosen from lingerie, under garments, night wear, dresses, blouses, outerwear, swimsuits, leisure sportswear, active sportswear, yoga wear, shapewear, t-shirts, stockings, sheets, pillow cases, upholstery fabrics, carpeting, fine lace, mesh cloth, etc. Further examples of suitable articles of apparel can be found in U.S. Pat. Nos. 10,271,581; 10,265,564; 10,233,577; and 10,039,332, incorporated herein by reference.

In other embodiments, the polymer compositions of the present invention may contain an additional, conventional additive which are added for specific purposes, such as antioxidants, thermal stabilizers, UV stabilizers, pigments and delusterants (for example titanium dioxide), dyes and dye enhancers, lubricating agents (for example silicone oil), additives to enhance resistance to chlorine degradation (for example zinc oxide; magnesium oxide and mixtures of huntite and hydromagnesite), and the like, so long as such additives do not produce antagonistic effects with the polymer components (a) and (b) of the invention.

### Examples

This invention can be further illustrated by the following examples of certain embodiments thereof, although it will be understood that these examples are included merely for purposes of illustration and are not intended to limit the scope of the invention unless otherwise specifically indicated.

The anti-tack behavior of the compositions of the invention was evaluated with a peel test performed in the following way:

Polyurethane (PU) solutions containing these cellulose ester compositions were spread on poly (ethylene terephthalate) (PET) film with RK 3 #bar (24 μm wet thickness) and dried with a hair dryer. The 25 mm×120 mm PU-coated PET strips were overlapped, loaded with 2 kg/cm² pressure, and stored in 50° C. for 6 days. The strips were then pulled apart, 180 degrees from one another, at 500 mm/min by a tensile meter (Labthink, type: FPT-F1). The maximum peel-off force was used to quantify the blocking performance, which simulates the unwinding tension. Higher peel force indicated poorer anti-blocking performance and higher unwinding tension, which can cause elastane fibers to break in the unwinding and knitting processes.

The effect of composition and dosage of CE on PU dope tackiness were evaluated using the method outlined above. Table 1 summarizes the composition (in degree of substitution of acetyl, propionyl, butyryl), T_{g}, and average number of side-chain carbons of several cellulose esters. Table 2 also lists the percent of the peel force of CE-free PU films after certain dosages of CE were added. A lower percent of the original peel force indicates less tackiness and higher anti-blocking performance due to the addition of the specific grade and dosage of CE.

TABLE 1
The composition, T_{g}, and average number of side-
chain carbons for cellulose ester compositions.

| | | | | | | | Average |
|---|---|---|---|---|---|---|---|
| | CE | Composition | | | | T_{g} | Side-Chain |
| Number | type | Ds Ac | Ds Pr | Ds Bu | Ds OH | (° C.) | Carbons |
| 1 | CAP | 0.15 | 2.38 | 0 | 0.47 | 142 | 7.44 |
| 2 | CAP | 0.18 | 2.5 | 0 | 0.32 | 147 | 7.86 |
| 3 | CAP | 0.06 | 2.11 | 0 | 0.83 | 159 | 6.45 |
| 4 | CAB | 2.1 | 0 | 0.72 | 0.18 | 160 | 7.08 |
| 5 | CAB | 1 | 0 | 1.67 | 0.33 | 141 | 8.68 |
| 6 | CAB | 0.13 | 0 | 2.51 | 0.36 | 101 | 10.30 |
| 7 | CP | 0 | 0 | 2.8 | 0.2 | 130 | 11.20 |
| 8 | CP | 0 | 0 | 2.74 | 0.26 | 132 | 10.96 |
| 9 | CAPB | 0.07 | 2.56 | 0.25 | 0.12 | 123 | 8.82 |
| 10 | CPB | 0.01 | 2.65 | 0.25 | 0.09 | 126 | 8.97 |

During the anti-tack testing, a low dosage of cellulose ester (CE) (0.5% solids) was the focus due to a number of formulation advantages in this scenario. The addition of a CE wold add manufacturing costs, so achieving the performance goal at a minimal loading is advantageous. Additionally, the mechanical mismatch between CEs (rigid) and elastane polyurethane (PU) (elastomeric) results in a loss of PU extensibility due to the presence of a CE. As elongation at break can be a differentiating factor between elastane grades, achieving acceptable anti-tack performance while minimizing the CE loading should also minimize the loss of extensibility.

TABLE 2
The percent reduction in peel force for
various grades and loading of CE in PU.

| | | % Original |
|---|---|---|
| | CE | Peel Force |
| Number | type | 0.5 wt % CE |
| 1 | CAP | 3.7% |
| 2 | CAP | 11.3% |
| 3 | CAP | 6.6% |
| 4 | CAB | 16.6% |
| 5 | CAB | 5.3% |
| 6 | CAB | 40.1% |
| 7 | CP | 0.9% |
| 8 | CP | 1.2% |
| 9 | CAPB | 3.8% |
| 10 | CPB | 2.6% |

As shown in Table 2, the inclusion of a cellulose ester in a polyurethane film does not guarantee adequate anti-tack during the peel test. The addition of 0.5% of CEs 1-6 to PU films did not achieve the desired performance targets. In several of these samples, the PU films failed during the peel test. However, the novel CEs introduced in this invention (samples 7-10) unexpectedly demonstrated superior anti-blocking behavior at dosages of 0.5% of the solids. As a result, the films exhibited low peel forces during the test, and the specimens remained intact.

From the standpoint of qualitative assessment of blocking/unblocking behavior of these experiments, Examples 2, 3, 4, and 6 exhibited severe blocking where the two films stuck together and broke when physically pulled apart. Examples 1 and 5 exhibited moderate blocking where the films remained intact when physically pulled apart. Finally, Examples 7-10 displayed acceptable anti-blocking performance as films were easily separated.

The invention has been described in detail with particular reference to certain embodiments thereof, but it will be understood that variations and modifications can be effected within the spirit and scope of the invention.

1. A polymer composition comprising
(a) at least one of a polymer chosen from polyolefins, nylons, polyesters, polyurethaneureas, and mixtures thereof; and
(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of about 0.01 to about 0.3;
(iv) a DS of hydroxyl of about 0.05 to about 0.25;
and a Mₙ of about 2000 to about 50,000.

2. The composition of claim 1, wherein the DS of propionyl is about 2.60 to about 2.80.

3. The composition of claim 1, wherein the DS of butyryl is about 0.10 to about 0.25.

4. The composition of claim 1, wherein the DS of hydroxyl is about 0.10 to about 0.20.

5. The composition of claim 1, wherein the number average molecular weight is about 5,000 to about 30,000.

6. The composition of claim 1, wherein the number average molecular weight is about 10,000 to about 20,000.

7. The composition of claim 1, wherein the cellulose ester is chosen from cellulose acetate propionate butyrate or cellulose propionate butyrate.

8. (canceled)

9. A fiber comprising:
(a) at least one of a polymer chosen from polyurethanes, polyolefins, nylons, polyesters, polyurethaneureas, and mixtures thereof; and
(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of about 0.01 to about 0.3;
(iv) a DS of hydroxyl of about 0.05 to about 0.25;
and a Mₙ of about 2000 to about 50,000
wherein the DS of propionyl is about 2.60 to about 2.80;
wherein the DS of butyryl is about 0.10 to about 0.25;
wherein the DS of hydroxyl is about 0.1 to about 0.20;
wherein the number average molecular weight is about 5,000 to about 30,000.

10-13. (canceled)

14. The fiber of claim 9, wherein the number average molecular weight is about 10,000 to about 20,000.

15. The fiber of claim 9, wherein the cellulose ester is chosen from cellulose propionate, cellulose acetate propionate butyrate, and cellulose propionate butyrate.

16-17. (canceled)

18. A process for preparing a fiber comprising:
(a) preparing a composition comprising at least one of a polymer chosen from polyurethanes, polyolefins, nylons, polyesters, polyurethaneureas, and mixtures thereof;
(b) about 0.1% to about 25% by weight of a cellulose ester having
(i) a DS of acetyl of about 0 to about 0.15;
(ii) a DS of propionyl of about 2.55 to about 2.85; and
(iii) a DS of butyryl of about 0.01 to about 0.3;
(iv) a DS of hydroxyl of about 0.05 to about 0.25;
and a Mₙ of about 2000 to about 50,000;
(c) adding to the composition at least one lubricant; and
(d) preparing fiber from the composition by a spinning process chosen from wet spinning, dry spinning, and melt spinning.

19. The process of claim 18, wherein the lubricant is chosen from calcium stearate, magnesium stearate, silicon oil, mineral oil, and mixtures thereof.

20-26. (canceled)
